(19) United States
(12) Patent Application Publication
(10) Pub. No.: US 2024/0160693 A1
(43) Pub. Date: May 16, 2024

(54) ERROR TOLERANT AI ACCELERATORS

(71) Applicant: Rain Neuromorphics Inc., San Francisco, CA (US)

(72) Inventors: Mohammed Elneanaei Abdelmoneem Fouda, Irvine, CA (US); Ross Pantone, Pacifica, CA (US)

(21) Appl. No.: 18/388,161

(22) Filed: Nov. 8, 2023

Related U.S. Application Data
(60) Provisional application No. 63/424,333, filed on Nov. 10, 2022.

(51) Int. Cl. G06F 17/16

(52) U.S. Cl. CPC G06F 17/16

(57) ABSTRACT

A compute engine including a compute-in-memory (CIM) hardware module and weight decomposition write circuitry is described. The CIM hardware module stores weights corresponding to a matrix. The CIM hardware module is configured to perform a vector-matrix multiplication (VMM) for the matrix. The weight decomposition write circuitry is coupled with the CIM hardware module and is configured to store weight decomposition data corresponding to the matrix. The weight decomposition write circuitry is also configured to determine a replacement matrix for the matrix from the weight decomposition data and to provide the replacement matrix to the CIM hardware module.

### CROSS REFERENCE TO OTHER APPLICATIONS

This application claims priority to U.S. Provisional Patent Application No. 63/424,333 entitled FAST HARDWARE REFRESHMENT METHOD FOR DNN ACCELERATORS IN RADIATIVE ENVIRONMENTS filed Nov. 10, 2022, which is incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. Thus, the weight layer provides weighted input signals to an activation layer. Neurons in the activation layer operate on the weighted input signals by applying some activation function (e.g. ReLU or Softmax) and provide output signals corresponding to the statuses of the neurons. The output signals from the activation layer are provided as input signals to the next weight layer, if any. This process may be repeated for the layers of the network. Learning networks are thus able to reduce complex problems to a set of weights and the applied activation functions. The structure of the network (e.g., number of layers, connectivity among the layers, dimensionality of the layers, the type of activation function, the values of the weights, etc.) is known as a model. Learning networks can leverage hardware, such as graphics processing units (GPUs) and/or AI accelerators, which perform operations usable in machine learning in parallel. Such tools can dramatically improve the speed and efficiency with which data-heavy and other tasks can be accomplished by the learning network.

In order to be used in data-heavy tasks and/or other applications, the learning network is trained prior to its use in an application. Training involves determining an optimal (or near optimal) configuration of the high-dimensional and nonlinear set of weights. Supervised training may include evaluating the final output signals of the last layer of the learning network based on a set of target outputs (e.g., the desired output signals) for a given set of input signals and adjusting the weights in one or more layers to improve the correlation between the output signals for the learning network and the target outputs. Once the correlation is sufficiently high, training may be considered complete. The model can then be deployed for use. Deploying the model includes copying the weights into a memory (or other storage) of the device on which the model is desired to be used. For example, the weights may be copied into the AI accelerator or storage for the GPU.

Once deployed, learning networks may be used for a variety of tasks and in a variety of environments. In some of these environments, the AI accelerators may be subject to conditions that are likely to cause errors. For example, a learning network may be exposed to radiation. This may occur when the learning network is used with or near radiative equipment, such as medical equipment or other devices that utilize x-rays or other radiation. This may also occur if the learning network is used in certain environments, for example in space or other environments where particulate and other radiation may occur. Errors may also occur at low or at high temperatures. The wide range of temperatures, radiation, and other issues may be addressed using radiation-hardened memory. Although radiation-hardened memory is available, this type of memory increases the area of the memory cells and/or the power consumed by a factor of two to three. This is undesirable. Accordingly, what is desired is a technique for hardening of the AI accelerator against errors introduced, for example by radiative environments.

### BRIEF DESCRIPTION OF THE DRAWINGS

Various embodiments of the invention are disclosed in the following detailed description and the accompanying drawings.

FIGS. 1A-1B depict an embodiment of a compute engine usable in a learning network and an embodiment of the weight decomposition write circuitry included therein.

FIG. 2 depicts an embodiment of a compute engine usable in a learning network and including weight decomposition write circuitry.

FIG. 3 depicts an embodiment of a portion of a compute-in-memory module usable in an AI accelerator.

FIG. 4 depicts an embodiment of a portion of a compute-in-memory module usable in an AI accelerator.

FIG. 5 depicts an embodiment of a portion of a compute-in-memory module usable in an AI accelerator.

FIG. 6 depicts an embodiment of a compute engine usable in a learning network, capable of performing including on-chip learning, and including weight decomposition write circuitry.

FIG. 7 depicts an embodiment of a tile including compute engines usable in a learning network.

FIG. 8 is a flow chart depicting an embodiment of a method for changing weights usable in an AI accelerator.

FIG. 9 is a flow chart depicting an embodiment of a method for providing weight decomposition data in an AI accelerator.

FIG. 10 is a flow chart depicting an embodiment of a method for using an AI accelerator capable of addressing faults.

FIG. 11 is a flow chart depicting an embodiment of a method for providing an AI accelerator capable of addressing faults.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A compute engine including a compute-in-memory (CIM) hardware module and weight decomposition write circuitry is described. The CIM hardware module stores weights corresponding to a matrix. The CIM hardware module is configured to perform a vector-matrix multiplication (VMM) for the matrix. The vector may be an input vector in the form of applied voltages or currents to the inputs of the CIM hardware module. The weight decomposition write circuitry is coupled with the CIM hardware module and is configured to store weight decomposition data corresponding to the matrix. The weight decomposition data may be used in reconstructing the weights of the CIM hardware module (e.g. due to errors or for other reasons), loading weights into the CIM hardware module, and/or other analogous functions. The weight decomposition write circuitry is also configured to determine a replacement matrix for the matrix from the weight decomposition data and to provide the replacement matrix to the CIM hardware module. In some embodiments, the weight decomposition data is stored in radiation-hardened memory.

In some embodiments, the weight decomposition write circuitry is configured to store a first vector (e.g. in first vector storage) and a second vector (e.g. in a second vector storage). The first and second vectors are thus stored instead of weight decomposition circuitry receiving the vectors as inputs. The first and/or second vector may be stored in radiation-hardened memory. The weight decomposition write circuitry provides a product of the first vector and the second vector as the replacement matrix and writes the product to the CIM hardware module. Thus, the weight decomposition write circuitry may include product circuitry coupled with the first and second vector storage. The product circuitry provides the product of the first vector and the second vector. The write circuitry is coupled with the product circuitry and the CIM hardware module. The write circuitry writes the product of the first and second vectors to the CIM hardware module. The CIM hardware module may include storage and compute circuitry. The storage circuitry stores the weights. The compute circuitry is coupled with the storage circuitry and performs the VMM for the weights.

The computer engine may also include a controller coupled with the CIM hardware module and weight decomposition write circuitry. The controller controls the weight decomposition write circuitry to determine the replacement matrix and write the replacement matrix in a first mode. The controller also controls the CIM hardware module to perform the VMM in a second mode.

A system including a processor and computer engines is also described. This system may be used as part of a learning network. The compute engines are coupled with the processor. Each compute engine includes a CIM hardware module and weight decomposition write circuitry. The CIM hardware module stores weights corresponding to a matrix and performs a VMM for the matrix. The weight decomposition write circuitry is coupled with the CIM hardware module and stores weight decomposition data corresponding to the matrix. The weight decomposition write circuitry also determines a replacement matrix for the matrix from the weight decomposition data and provides the replacement matrix to the CIM hardware module.

The weight decomposition write circuitry may store a first vector and a second vector, provide a product of the first vector and the second vector as the replacement matrix, and write the product to the CIM hardware module. The first and second vectors may each have a rank of one. The product corresponds to the matrix. In some embodiments, the first and/or second vectors are stored in radiation-hardened vector memory.

The weight decomposition write circuitry may include first and vector storage that store the first and second vectors, product circuitry coupled with the first and second vector storage, and write circuitry. The write circuitry is coupled with the product circuitry and the CIM hardware module. The product circuitry provides the product to the first write circuitry. The write circuitry writes the product to the CIM hardware module. The CIM hardware module may include storage circuitry that stores the weight and compute circuitry that is coupled with the storage circuitry and performs the VMM for the weights. The first vector and/or the second vector may be stored in the radiation-hardened memory. The compute engine may also include a controller configured to control the weight decomposition write circuitry to determine the replacement matrix and write the replacement matrix in a first mode. The controller may also control the CIM hardware module to perform the VMM in a second mode.

In some embodiments, each compute engine includes a local update module coupled with the CIM hardware module and/or the weight decomposition write circuitry. The local update module is configured to update at least one of the first vector, the second vector, and at least a portion of the plurality of weights.

In some embodiments, the processor and the compute engines are in a tile of a plurality of tiles. In some embodiments, the compute engines are in one or more tiles coupled with the processor.

A method is described. The method includes determining a replacement matrix for a matrix corresponding to weights stored in a CIM hardware module. The CIM hardware module performs a VMM for the matrix. The matrix has a matrix rank. The replacement matrix is determined from weight decomposition data stored in weight decomposition write circuitry. The weight decomposition data corresponds to the matrix. The method also provides, using the weight decomposition write circuitry, the replacement matrix to the CIM hardware module.

In some embodiments, the weight decomposition data includes first and second vectors, each of which may have a rank of one. The weight decomposition write circuitry may include radiation-hardened memory that stores the first vector and/or the second vector. In such embodiments, determining the replacement matrix further includes providing a product of the first vector and the second vector as the replacement matrix. The product corresponds to the matrix. In such embodiments, providing the replacement matrix to the CIM hardware module includes writing the product to the CIM hardware module. Thus, the matrix may be replaced by the replacement matrix. In some embodiments, the replacement matrix may be used to address errors in the matrix or may be used to change the model (i.e. change the weights stored by the CIM hardware module).

In some embodiments, the method also determines the first vector and the second vector based on the matrix. For example, a factorization, decomposition and/or optimization technique may be used to determine the vectors. The matrix is stored in the CIM hardware module. The first vector and the second vector are stored in the weight decomposition write circuitry. Storing the matrix in the CIM hardware module may include determining the product of the first and second vectors and storing the product in the CIM hardware module.

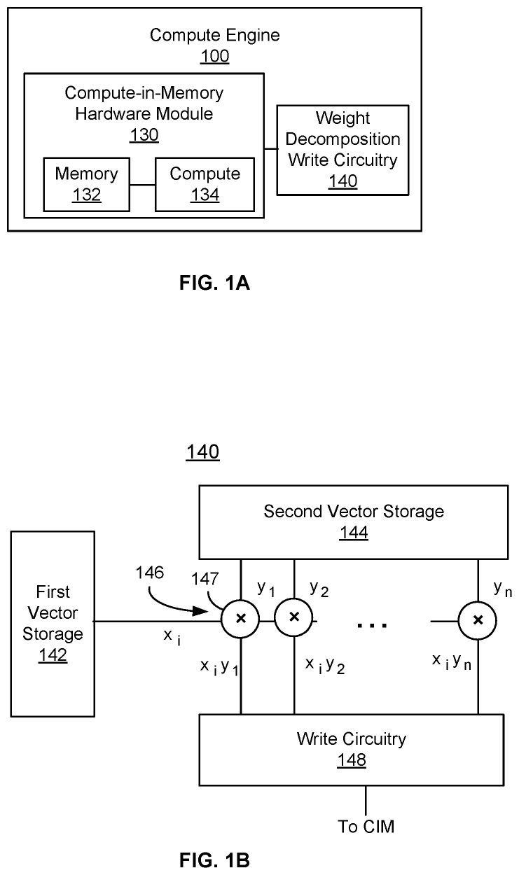

FIGS. 1A-1B depict an embodiment of compute engine 100 usable in a learning network and an embodiment of the weight decomposition write circuitry 140 that may be included therein. Compute engine 100 may be used in an artificial intelligence (AI) accelerator that can be deployed for using a model (not explicitly depicted), particularly in a radiative environment or under other harsh conditions. Compute engine 100 may be implemented as or as part of a single integrated circuit.

Compute engine includes a compute-in-memory (CIM) hardware module 130 and weight decomposition write circuitry 140. Compute engine 100 is configured to perform, efficiently and in parallel, tasks used in training and/or using a model. Compute engine 100 is coupled with and receives commands from another component, such as a processor (not shown). Although one CIM module 130 and one weight decomposition write circuitry 140 is shown in compute engine 100, a compute engine may include another number of CIM modules 130 and/or another number of weight decomposition write circuitry modules 140. As examples, a compute engine might include three CIM modules 130 and one weight decomposition write circuitry 140, one CIM module 130 and two weight decomposition write circuitry modules 140, or two CIM modules 130 and two weight decomposition write circuitry modules 140.

CIM hardware module 130 is a hardware module that stores data and performs operations. CIM hardware module 130 stores weights for the model and performs operations using the weights. More specifically, CIM hardware module 130 performs vector-matrix multiplications, where the vector may be an input vector provided to compute engine 100 and the matrix may be weights (i.e. data/parameters) stored by CIM hardware module 130. In some embodiments, the input vector may be a matrix (i.e. an n×m vector where n>1 and m>1). The matrix stored by CIM hardware module 130 has a matrix rank. The matrix rank is the dimension of the vector space spanned by the columns of the matrix. For example, rank of a matrix may be not more than the number of elements in a column (i.e. the number of rows).

CIM hardware module 130 may include memory 132 (e.g. that stores the weights) interconnected with compute hardware 134 (e.g. that performs the vector-matrix multiplication of the stored weights). CIM hardware module 130 may include an analog static random access memory (SRAM) having multiple SRAM cells (i.e. memory 132) and configured to provide output(s) (e.g. voltage(s)) corresponding to the data (weight/parameter) stored in each cell of the SRAM multiplied by a corresponding element of the input vector (i.e. using compute hardware 134). In some embodiments CIM hardware module 130 may include a digital static SRAM having multiple SRAM cells and configured to provide output(s) corresponding to the data (weight/parameter) stored in each cell of the digital SRAM multiplied by a corresponding element of the input vector. In some embodiments, CIM hardware module 130 may include an analog resistive random access memory (RAM) configured to provide output (e.g. voltage(s)) corresponding to the impedance of each cell multiplied by the corresponding element of the input vector. Other configurations of CIM hardware module 230 are possible. Each CIM hardware module 130 thus stores weights corresponding to a matrix in its cells and is configured to perform a vector-matrix multiplication of the matrix with an input vector.

Weight decomposition write circuitry 140 is coupled with CIM hardware module 130 and is configured to store weight decomposition data corresponding to the matrix and provide a replacement matrix for CIM hardware module 130 using the stored weight decomposition data. Stated differently, the desired values of the elements of the matrix stored by CIM hardware module 130 may be determined from the weight decomposition data. In some embodiments, the weight decomposition data has rank 1. Thus, weight decomposition data may be in the form of one or more vectors.

In some embodiments, weight decomposition write circuitry 140 stores the weight decomposition data in radiation-hardened memory (e.g. radiation-hardened analog SRAM, radiation-hardened digital SRAM, and/or radiation-hardened resistive RAM). Radiation-hardened memory may provide fault tolerance against radiation (e.g. x-rays, a-particles, etc.). In some embodiments, radiation-hardened memory provides fault tolerance for high and/or low temperatures (e.g. against thermal radiation). In some embodiments, radiation-hardened memory may simply include multiple cells for each piece of data stored. For example, instead of storing a particular bit of data in a single SRAM cell, radiation-hardened SRAM may include two or three SRAM cells for each bit of data. When the data is read from the radiation-hardened memory, the contents of each of the cells are read at least once and some statistical measure of the contents (the average, the maximum, minimum, etc.) is taken as the data. Other types of radiation-hardened memory may be used in some embodiments.

Using the weight decomposition data, weight decomposition write circuitry 140 also generates the desired values of the elements of the matrix stored in CIM module 130. For example, FIG. 1B depicts an embodiment of weight decomposition write circuitry 140. Weight decomposition write circuitry 140 includes vector storage 142 and 144, product circuitry 146, and write circuitry 148. First vector storage 142 and second vector storage 144 each store weight decomposition data usable in providing the replacement matrix for CIM module 130. In some embodiments, the data stored by vector storage 142 and 144 has rank 1. Although termed vector storage, in some embodiments, storage 142 and/or 144 may store a matrix (or vector) having a rank of greater than one. In the embodiment shown, if an m×n matrix is stored in CIM module 130, a vector x is stored in vector storage 142, and a vector y is stored in second vector storage 144. In some embodiments, x may be an m×1 vector and y may be a 1×n vector. In some embodiments, x may be an m×d vector and y may be a d×n vector (or matrix as d>1). In some such embodiments, d<min(m, n). In the context of weight decomposition write circuitry 140, therefore, a vector can include a matrix.

Weight decomposition data includes data from which weights for CIM hardware module 130 can be determined. Weight decomposition data generally consumes less memory than CIM hardware module 130 if radiation-hardened circuitry is not used. Stated differently, weight decomposition data can generally be stored in fewer unique cells (as opposed to cells that are copied) to are used to store weight decomposition data than are used to store the weights. For example, if the matrix of the weights is 64×64 (4096 weights) and uses 4096 storage cells, then vector storage 142 and 144 may store a 64×1 vector and a 1×64 vector, respectively. Other vectors (including matrices) might be used in other embodiments.

Weight decomposition write circuitry 140 is also configured to determine a replacement matrix for the matrix from the weight decomposition data and to provide the replacement matrix to the CIM hardware module. Weight decomposition write circuitry 140 thus include product circuitry 146. Product circuitry 146 includes one or more cells 147 that provide a product of an element from the first vector in first vector storage 142 and an element from the second vector in second vector storage 144. Thus, product circuitry 146 may fetch data from vector storage 142 and 144 and output to write circuitry 148 the product of the data stored. In some embodiments, there are at least m cells 147 for vector storage 144 being capable of storing a 1×m vector. In the embodiment shown, a single element (x) is provided to each cell 147 of product circuitry 146. Thus, xᵢ is provided to each cell 147, and the corresponding yⱼ (i.e. y₁, y₂, . . . , yₙ) provided to the cell 147. Each cell 147 multiplies the inputs to provide products xiy₁, xiy₂ . . . , xiyₙ for each row i of vector x and, therefore, each row i of the matrix of CIM module 130. Using write circuitry 148, the row can be written to the appropriate memory cell(s) (i.e. row) of the CIM module 130. This process is repeated for each row of the matrix of weights stored in CIM module 130. Consequently, the weight decomposition data stored in first vector storage 142 and second vector storage 144 can be combined to form a matrix for CIM module 130.

For an inference in a learning network, a layer of weights receives an input signal and outputs a weighted signal that corresponds to a vector-matrix multiplication of the input signal with the weights. An activation layer receives the weighted signal from the adjacent layer of weights and applies the activation function, such as a ReLU or sigmoid. The output of the activation layer may be provided to another weight layer or an output of the system. In compute engine 100, CIM module 130 corresponds to a layer of weights (or a portion thereof). The input vector may be provided (e.g. from a cache, from a source not shown as part of compute engine 100, or from another source) to CIM module 130. CIM module 130 performs a vector-matrix multiplication of the input vector with the weights stored in its cells. The weighted output may be provided to component(s) corresponding to an activation layer. For example, a processor (not shown) may apply the activation function and/or other component(s) (not shown) may be used. The output of the activation layer may be provided to another CIM module in another compute engine (or to CIM module 130 on compute engine 100 if CIM module 130 is used for multiple layers of weights). Thus, an inference may be performed.

Although an inference can be performed efficiently using CIM module 130, errors may be introduced into the memory cells of CIM module 130. For example, through exposure to heat or cold, exposure to radiation, extensive usage, or for other reasons, data in stored in memory 132 of CIM module 130 may be corrupted. As a result, the inference performed using compute engine 100 may not provide expected or desired results. These errors in weights stored in CIM module 130 are desired to be corrected. To do so, the weight decomposition data stored in weight decomposition write circuitry 140 may be processed to obtain a replacement matrix. For example, first and second vectors stored in first vector storage 142 and second vector storage 144, respectively, may be multiplied (e.g. element by element) using cells 147 of product circuitry 146 to provide the replacement matrix. In some embodiments, each of the elements of the replacement matrix (i.e. the product of the first and second vectors) are stored in the corresponding cells of memory 132 of CIM hardware module 130. In some embodiments, the elements of the replacement matrix are compared with the data stored in the corresponding cells of memory 132 and the elements written to the corresponding cells only if the there is a mismatch. The replacement matrix may reconstruct the matrix originally stored in memory 132 of CIM module 130. The model stored in compute engine 100 may thus be reconstructed.

In some embodiments, the model used by compute engine 100 may also be changed using weight decomposition write circuitry 140. In such embodiments, weights for the new model are decomposed into vectors. These vectors are loaded into vector storage 142 and 144. Using product circuitry 146, the product of these vectors is determined. Write circuitry 148 write this product to CIM hardware module 130. Thus, the product (i.e. a replacement matrix) replaces the weights stored in CIM hardware module 130 with new weights for a different model.

Using compute engine 100, efficiency, performance, and reliability of a learning network may be improved. Use of CIM module 130 may dramatically reduce the time to perform the vector-matrix multiplication that provides the weighted signal. Thus, performing inference(s) using system 100 may require less time and power. Use of weight decomposition write circuitry 140 also improves performance and reliability. Weight decomposition write circuitry 140 can be used to restore the matrix stored in CIM module 130. This restoration might occur periodically (e.g. based on the expected time to introduce a particular number of errors), in response to performance of the model of the learning network suffering, and/or for other reasons. Compute engine 100 can also load new models by loading the (new) vectors corresponding to the new models in vector storage 142 and 144 and using weight decomposition write circuitry 140 to generate the replacement matrix from these vectors and write the replacement matrix to memory 132 of CIM hardware module 130. The time taken to load new models may also be greatly reduced. Efficiency of compute engine 100 is again improved.

Further, weight decomposition write circuitry 140 may store weight decomposition data in radiation-hardened memory. The replacement matrix provided via radiation-hardened weight decomposition write circuitry 140 is more likely to be error-free (or have reduced errors). Efficiency, performance, and reliability of a learning network provided using compute engine 100 may be increased. Because weight decomposition write circuitry 140 stores weight decomposition data, less memory is consumed by the data (e.g. the first and second vectors) than if a radiation-hardened configuration were simply used for memory 132 of CIM hardware module 130. For example, even if each radiation-hardened memory cell in weight decomposition write circuitry 140 includes two or three memory cells, the number of radiation-hardened cells required by weight decomposition write circuitry 140 is significantly less than the number of radiation-hardened cells that would be required for memory 132 of CIM module 130. In the example above for a 64×64 matrix of weights (i.e. 4096 weights) stored in memory 132 and assuming vector memory 142 and 144 each includes three cells for each of the sixty-four elements of the corresponding vector, three hundred and eighty four elements are stored. If the CIM memory 132 were made radiation-hardened in a similar manner, 12288 elements would be stored. In some embodiments, the increase in overhead for a radiation-hardened configuration in weight decomposition write circuitry 140 is on the order of ten to twenty percent instead of two hundred to three hundred percent if radiation-hardened configuration is used for CIM hardware module 130. Thus, the benefits of compute engine 100 may be achieved in a smaller area. Further, the time taken to read and power consumed in reading radiation-hardened cells for weight decomposition write circuitry 140 may be significantly less than for a radiation-hardened configuration of CIM hardware module 130, which has significantly more cells. Thus, efficiency may be further improved while achieving a fault tolerant compute engine 100.

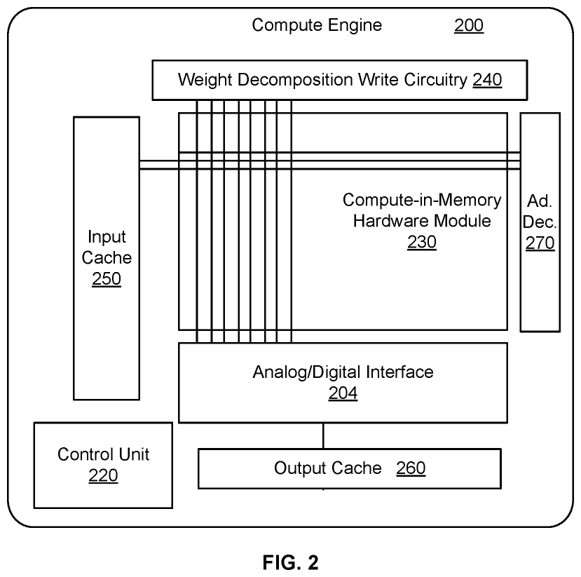

FIG. 2 depicts an embodiment of a compute engine 200 usable in a learning network and including weight decomposition write circuitry 240. For example, compute engine 200 may be part of an AI accelerator. Compute engine 200 may be a hardware compute engine analogous to compute engine 100. Compute engine 200 thus includes CIM module 230 and weight decomposition write circuitry 240 analogous to CIM module 130 and weight decomposition write circuitry 140, respectively. Compute engine 200 also includes analog/digital interface 204, control unit 220, input cache 250, output cache 260, and address decoder 270. Although certain components are shown, other and/or additional components may be present. Although particular numbers of components 204, 230, 240, 250, 260, and 270 are shown, another number of one or more components 204, 230, 240, 250, 260, and 270 may be present.

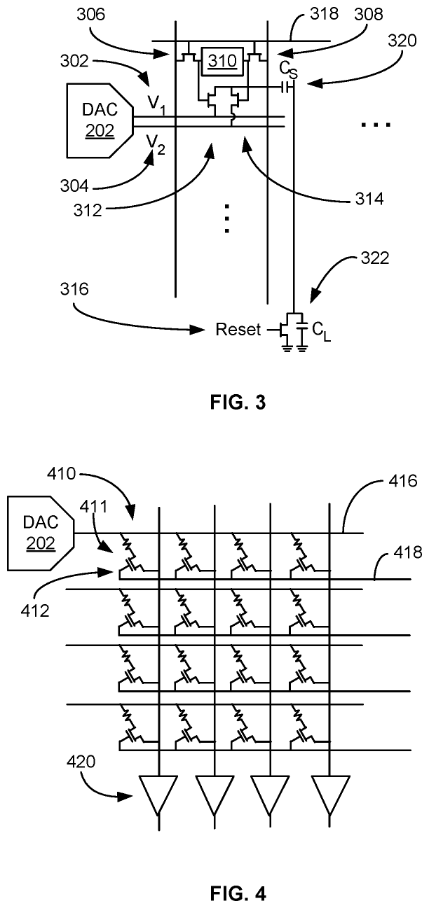

CIM module 230 is a hardware module that stores data corresponding to weights and performs vector-matrix multiplications. The vector is an input vector provided to CIM module 230 (e.g. via input cache 250) and the matrix includes the weights stored by CIM module 230. In some embodiments, the vector may be a matrix. Examples of embodiments CIM modules that may be used in CIM module 230 are depicted in FIGS. 3, 4, and 5.

FIG. 3 depicts an embodiment of a cell in one embodiment of an SRAM CIM module usable for CIM module 230. Also shown is DAC 202 of compute engine 200. For clarity, only one SRAM cell 310 is shown. However, multiple SRAM cells 310 may be present. For example, multiple SRAM cells 310 may be arranged in a rectangular array. An SRAM cell 310 may store a weight or a part of the weight. The CIM module shown includes lines 302, 304, and 318, transistors 306, 308, 312, 314, and 316, capacitors 320 (Cs) and 322 (CL). In the embodiment shown in FIG. 3, DAC 202 converts a digital input voltage to differential voltages, V₁ and V₂, with zero reference. These voltages are coupled to each cell within the row. DAC 202 is thus used to temporal code differentially. Although not shown in FIG. 2, one or more DAC(s) 202 may be connected between input cache 250 and CIM module 230. Lines 302 and 304 carry voltages V₁ and V₂, respectively, from DAC 202. Line 318 is coupled with address decoder 270 (not shown in FIG. 3) and used to select cell 310 (and, in the embodiment shown, the entire row including cell 310), via transistors 306 and 308.

In operation, voltages of capacitors 320 and 322 are set to zero, for example via Reset provided to transistor 316. DAC 202 provides the differential voltages on lines 302 and 304, and the address decoder (not shown in FIG. 3) selects the row of cell 310 via line 318. Transistor 312 passes input voltage V₁ if SRAM cell 310 stores a logical 1, while transistor 314 passes input voltage V₂ if SRAM cell 310 stores a zero. Consequently, capacitor 320 is provided with the appropriate voltage based on the contents of SRAM cell 310. Capacitor 320 is in series with capacitor 322. Thus, capacitors 320 and 322 act as capacitive voltage divider. Each row in the column of SRAM cell 310 contributes to the total voltage corresponding to the voltage passed, the capacitance, Cs, of capacitor 320, and the capacitance, CL, of capacitor 322. Each row contributes a corresponding voltage to the capacitor 322. The output voltage is measured across capacitor 322. In some embodiments, this voltage is passed to analog/digital interface 206. In some embodiments, analog/digital interface 206 includes an analog bit mixer for each column as well as an analog-to-digital converter (ADC) (not shown in FIG. 3). In some embodiments, capacitors 320 and 322 may be replaced by transistors to act as resistors, creating a resistive voltage divider instead of the capacitive voltage divider. Thus, using the configuration depicted in FIG. 3, CIM module 230 may perform a vector-matrix multiplication using data stored in SRAM cells 310.

FIG. 4 depicts an embodiment of a cell in one embodiment of a resistive CIM module usable for CIM module 230. Also shown is DAC 202 that is analogous to DAC 202 depicted in FIG. 3. For clarity, only one resistive cell 410 is labeled. However, multiple cells 410 are present and arranged in a rectangular array (i.e. a crossbar array in the embodiment shown). Also labeled are corresponding lines 416 and 418 and current-to-voltage sensing circuit 420. Each resistive cell includes a programmable impedance 411 and a selection transistor 412 coupled with line 418. Bit slicing may be used to realize high weight precision with multi-level cell devices.

In operation, DAC 202 converts digital input data to an analog voltage that is applied to the appropriate row in the crossbar array via line 416. The row for resistive cell 410 is selected by address decoder 270 (not shown in FIG. 4) by enabling line 418 and, therefore, transistor 412. A current corresponding to the impedance of programmable impedance 411 is provided to current-to-voltage sensing circuit 420. Each row in the column of resistive cell 411 provides a corresponding current. Current-to-voltage sensing circuit 420 senses the partial sum current from and to convert this to voltage. In some embodiments, this voltage is passed to analog/digital interface 206. In other embodiments, currents from resistive cells 411 may be provided as the vector-matrix multiplication. Thus, using the configuration depicted in FIG. 4, CIM module 230 may perform a vector-matrix multiplication using data stored in resistive cells 410.

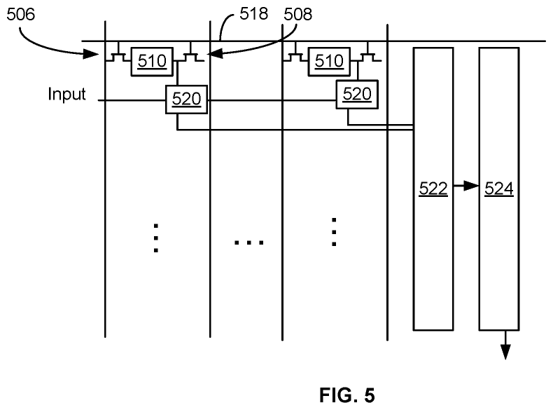

FIG. 5 depicts an embodiment of a cell in one embodiment of a digital SRAM module usable for CIM module 230. For clarity, only one digital SRAM cell 510 is labeled. However, multiple cells 510 are present and may be arranged in a rectangular array. Also labeled are corresponding transistors 506 and 508 for each cell, line 518, logic gates 520, adder tree 522 and digital mixer 524. Because the SRAM module shown in FIG. 5 is digital, DACs 202 and analog/digital interface 206 may be omitted from compute engine 200 depicted in FIG. 2.

In operation, a row including digital SRAM cell 510 is enabled by address decoder 270 (not shown in FIG. 5) using line 518. Transistors 506 and 508 are enabled, allowing the data stored in digital SRAM cell 510 to be provided to logic gates 520. Logic gates 520 combine the data stored in digital SRAM cell 510 with the input vector. Thus, the binary weights stored in digital SRAM cells 510 are combined with the binary inputs. The output of logic gates 520 are accumulated in adder tree 522 and combined by digital mixer 524. Thus, using the configuration depicted in FIG. 5, CIM module 230 may perform a vector-matrix multiplication using data stored in digital SRAM cells 510.

Referring back to FIG. 2, CIM module 230 thus stores weights corresponding to a matrix in its cells and is configured to perform a vector-matrix multiplication of the matrix with an input vector. In some embodiments, compute engine 200 stores positive weights in CIM module 230. However, the use of both positive and negative weights may be desired for some models and/or some applications. In such cases, bipolar weights (e.g. having range −S through +S) are mapped to a positive range (e.g. O through S). For example, a matrix of bipolar weights, W, may be mapped to a positive weight matrix Wₚ such that: Wₓ=(Wₚ−SJ/2)(2x)=2Wₚx−SΣᵢXᵢ where J is a matrix of all ones having the same size as W and S is the maximum value of the weight (e.g. 2^{N-1}-1 for an N-bit weight). For simplicity, compute engine 200 is generally discussed in the context of CIM module 230 being an analog SRAM CIM module analogous to that depicted in FIG. 3.

Input cache 250 receives an input vector for which a vector-matrix multiplication is desired to be performed. In some embodiments, the input vector is provided to input cache by a processor. The input vector may be read from a memory, from a cache or register in the processor, or obtained in another manner. In some embodiments, one or more DAC(s) (not shown in FIG. 2) converts a digital input vector to analog in order for CIM module 230 to operate on the vector. Address decoder 270 includes address circuitry configured to selectively couple weight decomposition write circuitry 240 and input cache 250 with each cell of CIM module 230. Address decoder 270 thus selects the cells in CIM module 230. For example, address decoder 270 may select individual cells, rows, or columns to be updated, replaced, undergo a vector-matrix multiplication, or output the results.

Compute engine 200 may also include control unit 220. Control unit 220 generates the control signals depending on the operation mode of compute engine 200. Control unit 220 is configured to provide control signals to CIM hardware module 230 and weight decomposition write circuitry 240. Some of the control signals correspond to an inference mode. In such a mode, compute engine 200 performs inferences. For example, CIM hardware module 230 performs vector matrix multiplications in such a mode. Some of the control signals correspond to an error correction or weight replacement mode. In such embodiments, some or all of the weights stored in CIM hardware module 230 are replaced using data in weight decomposition write circuitry 240. In some embodiments, the mode is controlled by a control processor (not shown in FIG. 2) that generates control signals based on the Instruction Set Architecture (ISA). The error correction or weight replacement mode may be used when initially loading weights into CIM module 230 from weight decomposition write circuitry 240, when loading new weights into CIM module 230 from weight decomposition write circuitry 240 for example for a change in the model, or when accounting for errors by replacing the weights in CIM module 230 using weight decomposition write circuitry 240.

Weight decomposition write circuitry 240 is analogous to weight decomposition write circuitry 140. Weight decomposition write circuitry 240 is coupled with CIM hardware module 230 and is configured to store weight decomposition data corresponding to the matrix for CIM hardware module 230 and to provide a replacement matrix for CIM hardware module 230 using the stored weight decomposition data. Consequently, weight decomposition write circuitry 240 may include first vector storage 142, second vector storage 144, product circuitry 146 that may include cells 147, and write circuitry 148. Moreover, weight decomposition write circuitry 240 may store weight decomposition data in radiation-hardened memory. For example, vector storage 142 and/or 144 may be radiation-hardened memory.

In operation, an input vector may be provided from input cache 250 to CIM module 230. CIM module 230 performs a vector-matrix multiplication of the input vector with the weights stored in its cells. The weighted output may be provided to output cache 260 via analog/digital interface 204. Output cache 260 may provide the output to component(s) corresponding to an activation layer. For example, a processor (not shown) may apply the activation function and/or other component(s) (not shown) may be used. The output of the activation layer may be provided to another CIM module in another compute engine (or to CIM module 130 on compute engine 100 if CIM module 130 is used for multiple layers of weights). Thus, an inference may be performed.

In error correction/weight replacement mode, weight decomposition write circuitry 240 generates some or all of the replacement matrix from weight decomposition data. For example, a product of two vectors stored in radiation-hardened vector memory (e.g. memory 142 and 144) may be determined (e.g. using product circuitry 146). Based on this product (e.g. a replacement matrix), some or all of the weights in CIM hardware module 230 may be written. Thus, weight decomposition data that may be less subject to errors can be used to correct data for a matrix. In a similar manner, weight decomposition data may be used to load new models to CIM module 230.

Using compute engine 200, efficiency and performance of a learning network may be improved. Use of CIM module 230 may dramatically reduce the time to perform the vector-matrix multiplication that provides the weighted signal. Use of weight decomposition write circuitry 240 also improves performance and reliability. Weight decomposition write circuitry 240 can be used to restore the matrix stored in CIM module 230. Further, weight decomposition write circuitry 240 may store weight decomposition data in radiation-hardened memory. The replacement matrix provided via weight decomposition write circuitry 240 is then more likely to have fewer or no errors. Efficiency, performance, and reliability of a learning network provided using compute engine 200 may be increased. Because weight decomposition write circuitry 240 stores weight decomposition data, less memory is consumed by the data (e.g. the first and second vectors). Thus, the benefits of compute engine 200 may be achieved in a smaller area.

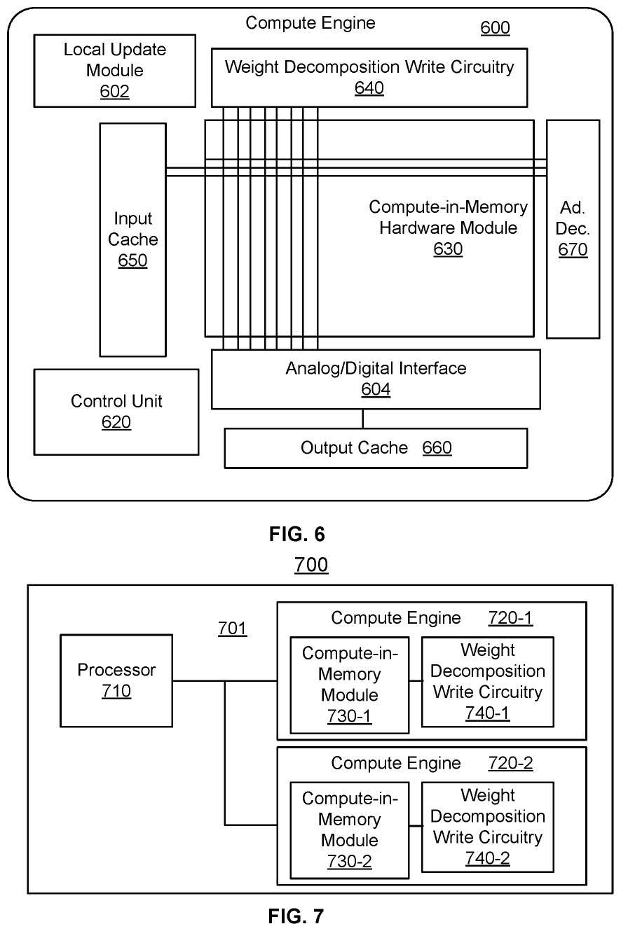

FIG. 6 depicts an embodiment of a compute engine 600 usable in a learning network and including weight decomposition write circuitry 640. For example, compute engine 600 may be part of an AI accelerator. Compute engine 600 may be a hardware compute engine analogous to compute engine 200. Compute engine 600 thus includes CIM module 630 and weight decomposition write circuitry 640 analogous to CIM module 130 and/or 230 and weight decomposition write circuitry 140/240, respectively. Compute engine 600 also includes analog/digital interface 604, control unit 620, input cache 650, output cache 660, and address decoder 670 that are analogous to analog/digital interface 204, control unit 220, input cache 250, output cache 260, and address decoder 270.

In order to facilitate on-chip learning, local update (LU) module 602 is provided. LU module 602 is coupled with the corresponding CIM module 630. LU module 602 may be coupled with weight decomposition write circuitry 640. LU module 602 is used to update the weights (or other data) stored in CIM module 630. LU module 602 is considered local because LU module 602 is in proximity and CIM module 630. For example, LU module 602 may reside on the same integrated circuit as CIM module 630. In some embodiments LU module 602 for a particular compute engine resides in the same integrated circuit as the CIM module 630 for the compute engine 600. In some embodiments, LU module 602 is considered local because it is fabricated on the same substrate (e.g. the same silicon wafer) as the corresponding CIM module 630. In some embodiments, LU module 602 is also used in determining the weight updates. In other embodiments, a separate component may calculate the weight updates. In some embodiments, LU module 602 may determine updates for another component in the integrated circuit (i.e. other than and/or in addition to for CIM module 630), for other tile(s) and/or other compute engine(s) (not shown).

In operation, LU module 602 may be used during training. For example, control unit 620 may also include a training mode that activates the use of LU module 602. During training, an inference may be performed using compute engine 600. Based on the difference between the output of the learning system and target outputs, the desired changes to weights stored in CIM module 630 may be determined. The determination of these weight updates may be made via LU module 602. The updates may be written to CIM module 630 using LU module 602. Thus, these updates are written directly to memory cells of CIM module 630. Once training is completed, the weights in CIM module are converted to weight decomposition data and stored in weight decomposition write circuitry 640. Weight decomposition data stored in weight decomposition write circuitry 640 may then be used to correct errors in CIM module 630.

Compute engine 600 shares the benefits of compute engines 100 and 200. Efficiency, reliability, and performance of a learning network using compute engine 600 may be improved while limiting the additional area consumed. Further, use of LU module 602 allows for on-chip training. Thus, performance and flexibility of compute engine 600 may be improved.

FIG. 7 depicts system 700 usable in a learning network. System 700 may be an AI accelerator that can be deployed for using a model (not explicitly depicted). System 700 may thus be implemented as a single integrated circuit. System 700 includes processor 710 and compute engine 720-1 and 720-2 (collectively or generically compute engine 720). Other components, for example a cache or another additional memory, mechanism(s) for applying activation functions, and/or other modules, may be present in system 700. Although a single processor 710 is shown, in some embodiments multiple processors may be used. In some embodiments, processor 710 is a reduced instruction set computer (RISC) processor. In other embodiments, different and/or additional processor(s) may be used. Processor 710 implements instruction set(s) used in controlling compute engines 720.

Compute engines 720-1 and 720-2 include CIM modules 730-1 and 730-2 (collectively or generically CIM module 730) and weight decomposition write circuitry 740-1 and 740-2 (collectively or generically weight decomposition write circuitry module 740). Compute engines 720 are analogous to compute engine(s) 100, 200, and/or 600. Although one CIM module 730 and weight decomposition write circuitry 740 is shown in each compute engine 700, a compute engine may include another number of CIM modules 730 and/or another number of weight decomposition write circuitry modules 740. For example, a compute engine might include three CIM modules 730 and weight decomposition write circuitry 740, one CIM hardware module 730 and two weight decomposition write circuitry 740, or two CIM modules 730 and two weight decomposition write circuitry 740.

Compute engines 720 operate in an analogous manner to compute engines 100, 200, and/or 600. System 700 shares the benefits of compute engines 100, 200, and/or 600. Thus, performance, efficiency, and reliability may be improved without unduly increasing the area consumed by compute engines 720. Further, compute engines 720 may be organized into tiles. Thus, compute engines may be organized and used in a hierarchical architecture.

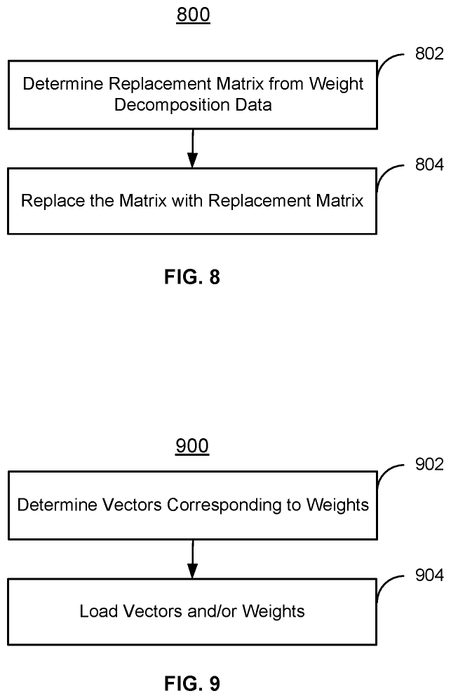

FIG. 8 is a flow chart depicting an embodiment of method 800 for changing weights stored in an AI accelerator. Method 800 may be used for addressing faults that may occur in an AI accelerator. Method 800 may also be used to initially load models or change models for the AI accelerator. In such cases, method 800 commences after the weight decomposition corresponding to the desired weights has been loaded into the weight decomposition write circuitry. Method 800 is described in the context of compute engine 200. However, method 800 is usable with other compute engines, such as compute engines 100, 600, and/or 720. Although particular processes are shown in an order, the processes may be performed in another order, including in parallel. Further, processes may have substeps.

A replacement matrix for a matrix corresponding to weights stored in a CIM hardware module is determined, at 802. Calculating the values of the entries of the replacement matrix in 802 includes the use of weight decomposition data. Weight decomposition data may consume less memory than the replacement matrix being formed or the matrix being replaced. In some embodiments, the weight decomposition data includes vectors (e.g. rank 1 data). The weight decomposition data used at 802 may also be stored in radiation-hardened memory. Further, 802 may include providing a product of two vectors, as indicated in FIG. 5.

The replacement matrix in written to the CIM hardware module, at 804. The replacement matrix thus overwrites (i.e. replaces) some or all of the weights in the CIM hardware module. Thus, any errors in matrix of weights stored in the CIM hardware module may be corrected using radiation-hardened values. Further, new models may be loaded into the CIM hardware module using method 800.

For example, weight decomposition write circuitry 240 may use weight decomposition data stored therein to calculate values for the replacement matrix, at 802. Replacement entries for the elements of matrix 300 stored in CIM hardware module 230, at 802. Weight decomposition write circuitry 240 also writes the values to the appropriate locations in CIM hardware module 830.

Using method 800, the benefits of compute engines 100, 200, 600, and 720 may be achieved. Efficiency, reliability, and performance of a learning network may be improved.

FIG. 9 is a flow chart depicting an embodiment of method 900 for providing weight decomposition data usable in an AI accelerator. In some embodiments, method 900 may be carried out after training is completed. Method 900 is described in the context of compute engine 100. However, method 900 is usable with other compute engines, such as compute engines 200, 600, and/or 720. Although particular processes are shown in an order, the processes may be performed in another order, including in parallel. Further, processes may have substeps.

The vectors which correspond to the matrix are determined, at 902. In some embodiments, 902 might be simply viewed as factoring the matrix into two vectors. However, in general the determination of the vectors corresponding to the matrix is an optimization problem. In some cases, 902 may include reordering of rows of the matrix as part of the optimization. Thus, the vectors corresponding to the matrix are generated. Stated differently, the desired weights are decomposed into the vectors to be used.

The vectors determined at 902 and the weights are loaded into the CIM hardware module, at 904. Thus, 904 includes storing the vectors in memory for weight decomposition write circuitry. Storing the weights may include storing the weights used in determining the vectors directly in the CIM hardware module. In some embodiments, however, storing the weights in the CIM hardware module may be carried out using weight decomposition write circuitry. For example, after the vectors are stored as part of 904, a product of the vectors may be calculated using weight decomposition write circuitry. The product is then written to the memory of the CIM hardware module also as part of 904.

For example, the vectors corresponding to the weights for the matrix for CIM hardware module 130 may be determined, at 902. The matrix of weights may have been determined by training the learning network in which CIM hardware module 130 is used.

At 904, the vectors are loaded into first vector storage 142 and second vector storage 144 of weight decomposition write circuitry 140. In some embodiments, 904 continues by loading the weights used in 902 into memory 132 of CIM hardware module. In other embodiments, product circuitry 146 determines the weight matrix from the vectors stored in vector storage 142 and 144 as part of 904. The weights for the matrix are written to memory 132 using write circuitry 148.

Using method 900, compute engines 100, 200, 600, and 720 may be provided and their benefits achieved. Efficiency, reliability, and performance of a learning network may be improved. Further, storing the weights initially using the vectors determined at 902 may reduce the time required to load the model into the computer engine. For example, in some cases loading of the weights in CIM hardware module 130 may be accomplished on the order of five microseconds if weight decomposition data is used. This is in contrast to five milliseconds to load weights directly to CIM hardware module from other memory. Thus, efficiency of providing an AI accelerator may also be improved.

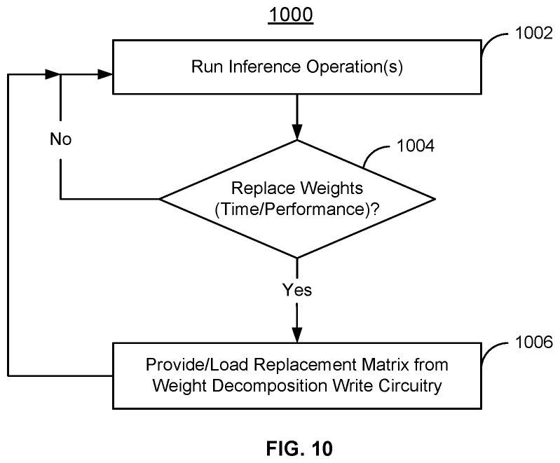

FIG. 10 is a flow chart depicting an embodiment of method 1000 for using an AI accelerator capable of addressing faults (i.e. errors). Method 1000 is described in the context of compute engine 200. However, method 1000 is usable with other compute engines, such as compute engines 100, 600, and/or 720. Although particular processes are shown in an order, the processes may be performed in another order, including in parallel. Further, processes may have sub steps.

One or more inferences are performed, at 1002. In general, multiple inferences are performed as part of using the compute engine in machine learning. It is determined whether the weights should be replaced, at 1004. In some embodiments, weights are replaced at regular intervals. For example, if a particular threshold number of errors is expected to occur in the CIM hardware module memory over a given length of time, the weights may be replaced at intervals less than or equal to the given length of time. Thus, 1004 may include determining whether the time interval has expired. In some embodiments, performance of the model is tested against benchmarks to provide an indication of the errors that have been introduced. If the performance does not meet the criteria, the weights are replaced. Thus, 1004 may include determining whether performance benchmarks are met.

If the weights are not to be replaced, additional inferences are performed, at 1002. If it is determined at 1004 that weights are to be replaced, then the replacement matrix is loaded into the CIM hardware module from the weight decomposition write circuitry, at 1006. Additional inferences may then be performed at 1002.

For example, inferences may be performed using compute engine 200, at 1002. It is determined whether the weights in CIM module 230 are to be replaced, at 1004. If not, normal operation may continue. If the weights are to be replaced, then the weights are generated from weight decomposition data in weight decomposition write circuitry 240 and written to CIM module 230.

Using method 1000, compute engines 100, 200, 600, and 720 may be used and their benefits achieved. Efficiency, reliability, and performance of a learning network may be improved. Thus, efficiency of providing an AI accelerator may also be improved.

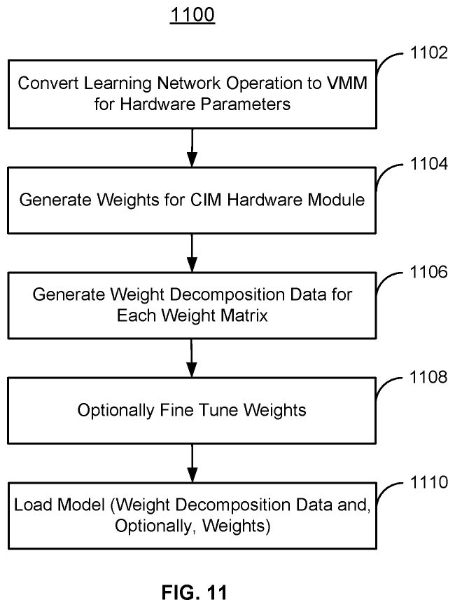

FIG. 11 is a flow chart depicting an embodiment of method 1100 for providing an AI accelerator capable of addressing faults. However, method 1100 is usable with compute engines, such as compute engines 100, 200, 600, and/or 720. Although particular processes are shown in an order, the processes may be performed in another order, including in parallel. Further, processes may have substeps.

Method 1100 commences after the neural network model has been determined. Further, initial hardware parameters have already been determined. The operation of the learning network is converted to the desired vector-matrix multiplications given the hardware parameters for the hardware compute engine, at 1102. Training takes place, at 1104. Thus, the desired weights for the CIM hardware module are determined. These weights are decomposed to provide the weight decomposition data, at 1106. In some embodiments, 1106 may be formulated as an optimization problem based on the desired properties of the vectors and the values of the weights. The weights may be fine-tuned, at 1108. The model may be loaded, at 1110. Thus, both the weight decomposition data and the corresponding matrix of weights are provided. In some embodiments, 1110 is analogous to 904.

Using method 1100, compute engines 100, 200, 600, and 720 may be provided and their benefits achieved. Efficiency, reliability, and performance of a learning network may be improved. Thus, efficiency of providing an AI accelerator may also be improved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A compute engine, comprising:
a compute-in-memory (CIM) hardware module storing a plurality of weights corresponding to a matrix and configured to perform a vector-matrix multiplication (VMM) for the matrix; and
weight decomposition write circuitry coupled with the CIM hardware module, the weight decomposition write circuitry configured to store weight decomposition data corresponding to the matrix, to determine a replacement matrix for the matrix from the weight decomposition data, and to provide the replacement matrix to the CIM hardware module.

2. The compute engine of claim 1, wherein the weight decomposition write circuitry is configured to store a first vector and a second vector, to provide a product of the first vector and the second vector as the replacement matrix, and to write the product to the CIM hardware module, the product corresponding to the matrix.

3. The compute engine of claim 2, wherein the CIM hardware module further includes:
storage circuitry configured to store the plurality of weights; and
compute circuitry coupled with the storage circuitry and configured to perform the VMM for the plurality of weights.

4. The compute engine of claim 2, wherein at least one of the first vector and the second vector are stored in radiation-hardened memory.

5. The compute engine of claim 2, wherein the weight decomposition write circuitry further includes:
first vector storage configured to store the first vector;
second vector storage configured to store the second vector;
product circuitry coupled with the first vector storage and the second vector storage, the product circuitry being configured to provide the product of the first vector and the second vector; and
write circuitry coupled with the product circuitry and the CIM hardware module, the write circuitry for writing the product to the CIM hardware module.

6. The compute engine of claim 5, further comprising:
a controller configured to control the weight decomposition write circuitry to determine the replacement matrix and write the replacement matrix in a first mode and to control the CIM hardware module to perform the VMM in a second mode.

7. A system, comprising:
a processor; and
a plurality of compute engines coupled with the processor, each of the plurality of compute engines including a compute-in-memory (CIM) hardware module and weight decomposition write circuitry, the CIM hardware module storing a plurality of weights corresponding to a matrix and configured to perform a vector-matrix multiplication (VMM) for the matrix, the weight decomposition write circuitry being coupled with the CIM hardware module, the weight decomposition write circuitry configured to store weight decomposition data corresponding to the matrix, to determine a replacement matrix for the matrix from the weight decomposition data, and to provide the replacement matrix to the CIM hardware module.

8. The system of claim 7, wherein the weight decomposition write circuitry is configured to store a first vector and a second vector, to provide a product of the first vector and the second vector as the replacement matrix, and to write the product to the CIM hardware module, the product corresponding to the matrix.

9. The system of claim 8, wherein the CIM hardware module further includes:
storage circuitry configured to store the plurality of weights; and
compute circuitry coupled with the storage circuitry and configured to perform the VMM for the plurality of weights.

10. The system of claim 8, wherein at least one of the first vector and the second vector are stored in radiation-hardened memory.

11. The system of claim 8, wherein the weight decomposition write circuitry further includes:
first vector storage configured to store the first vector;
second vector storage configured to store the second vector;
product circuitry coupled with the first vector storage and the second vector storage, the product circuitry being configured to provide the product of the first vector and the second vector; and
write circuitry coupled with the product circuitry and the CIM hardware module, the write circuitry for writing the product to the CIM hardware module.

12. The system of claim 11, wherein each of the plurality of compute engines further includes:
a controller configured to control the weight decomposition write circuitry to determine the replacement matrix and write the replacement matrix in a first mode and to control the CIM hardware module to perform the VMM in a second mode.

13. The system of claim 8, wherein each of the plurality of compute engines further includes:
a local update module coupled with at least one of the weight decomposition write circuitry and the CIM hardware module, configured to update at least one of the first vector, the second vector, and at least a portion of the plurality of weights.

14. The system of claim 8, wherein the processor and the plurality of compute engines are in a tile of a plurality of tiles.

15. The system of claim 8, wherein the plurality of compute engines are in at least one of a plurality of tiles.

16. The system of claim 15, wherein the plurality of compute engines are included in a learning network.

17. A method, comprising:
determining a replacement matrix for a matrix corresponding to a plurality of weights stored in a compute-in-memory (CIM) hardware module, the CIM hardware module being configured to perform a vector-matrix multiplication (VMM) for the matrix, the replacement matrix being determined from weight decomposition data stored in weight decomposition write circuitry, the weight decomposition data corresponding to the matrix; and
providing, using the weight decomposition write circuitry, the replacement matrix to the CIM hardware module.

18. The method of claim 17, wherein the weight decomposition data includes a first vector and a second vector, and wherein the determining further includes:
providing a product of the first vector and the second vector as the replacement matrix, the product corresponding to the matrix; and wherein the providing further includes
writing the product to the CIM hardware module, the matrix being replaced by the replacement matrix.

19. The method of claim 18, wherein the weight decomposition write circuitry further includes radiation-hardened memory, at least one of the first vector and the second vector being stored in the radiation-hardened memory.

20. The method of claim 18, further comprising:
determining the first vector and the second vector based on the matrix;
storing the matrix in the CIM hardware module; and
storing the first vector and the second vector in the weight decomposition write circuitry.

21. The method of claim 20, wherein the storing the matrix in the CIM hardware module further includes:
determining the product from the first vector and the second vector; and
storing the product in the CIM hardware module.
